(19) United States
(12) Patent Application Publication
(10) Pub. No.: US 2021/0069818 A1
(43) Pub. Date: Mar. 11, 2021

(54) WELDING GUN TRIGGER GUARD

(71) Applicant: Lippert Components, Inc., Elkhart, IN (US)

(72) Inventors: Jay Martin, Mishawaka, IN (US); Bryan Hershberger, Millersburg, IN (US); Eric Nielsen, Elkhart, IN (US); David Martin, Mishawaka, IN (US)

(21) Appl. No.: 17/010,597

(22) Filed: Sep. 2, 2020

Related U.S. Application Data
(60) Provisional application No. 62/896,082, filed on Sep. 5, 2019.

(51) Int. Cl. B23K 9/32; F16P 3/08

(52) U.S. Cl. CPC B23K 9/321; B23K 9/173; F16P 3/08

(57) ABSTRACT

A guard for a welding gun having a trigger and a body includes a plate having two elongated sides, two ends, a front, and a back, and a first pair of flanges extending from the elongated sides of the plate and forming a first open channel with the back of the plate. A biasing member is secured to the back of the plate. The plate is pivotally secured to the welding gun body by fasteners engaging the first pair of flanges and the welding gun body, and at least a portion of the back of the plate overlies the welding gun trigger. A user may only activate the gun by applying enough pressure to the plate to engage the trigger. When the user is not applying the required pressure, the spring-biasing mechanism prevents the trigger from being pressed.

### CROSS-REFERENCES TO RELATED APPLICATIONS

This application claims the benefit of U.S. Provisional Patent Application No. 62/896,082, filed Sep. 5, 2019, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a trigger guard for a welding gun

Welding guns are commonly used in the manufacture of heavy-duty equipment, vehicles, and machinery, which makes the manufacture and use of welding guns a constant need. In MIG welding, a solid wire electrode is continuously fed through the head of the gun as the trigger of the welding gun is held down. The wire is protected from contamination by a shielding gas and simultaneously melted by a current conductor to create the weld. A common but sometimes serious injury in welding occurs by unintentional pressing of the welding gun trigger, which has the potential to stab and burn the user due to the feed of wire electrode with heat. The welding gun trigger is sensitive enough for this to occur if the user mishandles it or if he or she sets it down in a place where it can accidentally make contact with an item or surface that applies pressure to the trigger.

It would be desirable to provide a safety feature for a welding gun to prevent unintentional pressing of the trigger without impeding efficient welding.

### SUMMARY

The welding gun of the described embodiments includes a trigger guard installed onto a welding gun to prevent unintentional pressing of the trigger. The trigger guard includes an elongated plate that is mounted to overlie the trigger of the welding gun. One end of the elongated plate has flanges for pivotally mounting the plate to the body of the welding gun. The other end of the plate includes a spring-biasing mechanism to bias the plate away from contact with the welding gun trigger. The trigger guard is pivotally mounted to be close enough to the body of the welding gun so that a user may only activate the gun by applying enough pressure to the plate to engage the trigger. When the user is not applying the required pressure, the spring-biasing mechanism prevents the trigger from being pressed.

In an exemplary embodiment, a guard for a welding gun having a trigger and a body includes a plate having two elongated sides, two ends, a front, and a back, a first pair of flanges extending from the elongated sides of the plate and forming a first open channel with the back of the plate, and a biasing member secured to the back of the plate. The plate is configured to be pivotally secured to the welding gun body by fasteners engaging the first pair of flanges and the welding gun body, and at least a portion of the plate overlies the welding gun trigger.

At least a portion of the back of the plate may extend beyond the welding gun trigger, where the biasing member is positioned to bias the plate away from the welding gun trigger. The plate may further include a second pair of flanges forming a second open channel with the back of the plate, where the biasing member is connected to the plate via the second pair of flanges. The biasing member may include a lever and a torsion spring.

The welding gun guard may include an aperture in the plate adjacent the second pair of flanges, where the lever extends from both sides of the aperture. In this context, the torsion spring may be mounted to the second pair of flanges and may be configured to bias the lever to extend from both sides of the aperture. The lever may be rotatable to a position disposed on one side of the aperture and parallel with the plate when pressure is applied to the plate.

The biasing member may include a lever connected to the plate and pivotable between an engaged position, in which the plate is prevented from displacement, and a disengaged position, in which the plate is freely displaceable to activate the welding gun trigger. The plate may include an aperture, where the lever may include a head pivoted through the aperture when the lever in in the engaged position, whereby the head is manually accessible and displaceable by an operator. In some embodiments, the biasing member may include a torsion spring connected between the plate and a stem of the lever that is configured to bias the lever toward the engaged position. The torsion spring may be U-shaped, extending from one side of the plate, across the stem of the lever, to an opposite side of the plate.

In some embodiments, the biasing member may be a compression spring connected to the plate and engageable with the welding gun body, where the compression spring is configured to bias the plate away from the trigger.

In another exemplary embodiment, a guard for a welding gun having a trigger and a body includes a plate having two elongated sides, two ends, a front, and a back, and a first pair of flanges extending from the elongated sides of the plate and forming a first open channel with the back of the plate. The plate is pivotally secured to the welding gun body by fasteners engaging the first pair of flanges and the welding gun body, and at least a portion of the back of the plate overlies and extends beyond the welding gun trigger. The back of the plate includes a compression spring biasing the plate away from the welding gun trigger. The pivotal movement of the plate may be limited to the height of the compression spring in a released position.

In yet another exemplary embodiment, a guard for a welding gun trigger forming part of a welding gun handle includes a plate pivotably mountable to the welding gun handle overlying the welding gun trigger, and a lever pivotably coupled with the plate. The plate is pivotable between a released position spaced from the welding gun trigger and an engaged position activating the welding gun trigger. The plate includes an aperture therein. The lever is extendable through the aperture in the plate. The lever is pivotable relative to the plate between an upright position essentially perpendicular to the plate and a flat position essentially parallel to the plate. The lever is biased toward the upright position via a biasing member, and in the upright position, the lever is engageable with the handle to prevent the plate from engaging the welding gun trigger.

### BRIEF DESCRIPTION OF THE DRAWINGS

These and other aspects and advantages will be described in detail with reference to the accompanying drawings, in which:

FIG. 1 is a perspective view of a welding gun trigger guard in the released position;

FIG. 2 is a side perspective view of the welding gun trigger guard of FIG. 1;

FIG. 3 is a side perspective view of the welding gun trigger guard of FIG. 1 in the engaged position;

FIG. 4 is a side perspective view of the bottom of a trigger guard plate; and

FIG. 5 is an illustration of an alternate embodiment of the welding gun trigger guard in the released position.

### DETAILED DESCRIPTION

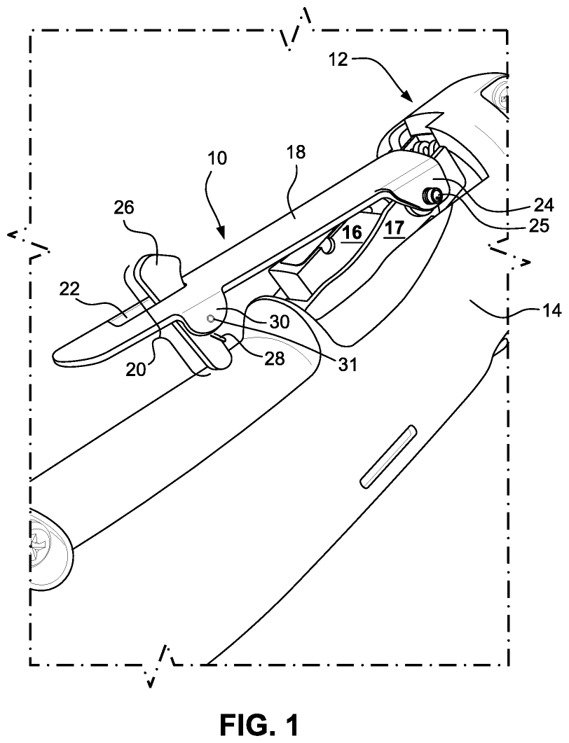

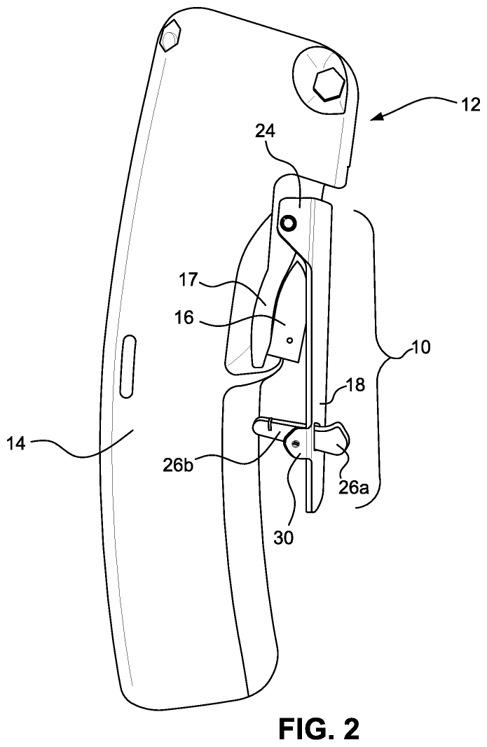

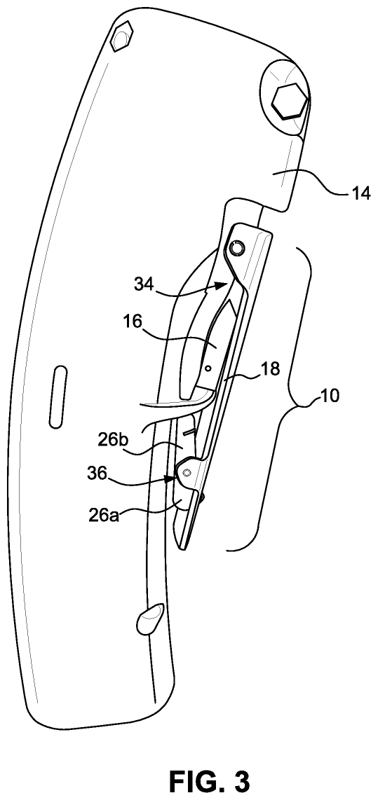

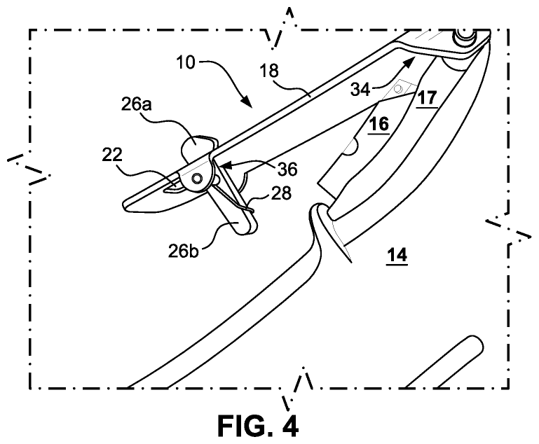

With reference to FIGS. 1-4, a welding gun trigger guard 10 is mounted onto a standard welding gun 12 having a body or handle 14 and a trigger 16. The trigger guard 10 may be installed with the manufacture of the welding gun or may be installed as an aftermarket product. The trigger guard 10 of FIGS. 1-2 includes an elongated plate 18 with four flanges, a biasing spring 20, and an aperture 22 accommodating for the biasing spring.

As shown in FIG. 1, the trigger guard 10 is mounted to a trigger base 17 surrounding a trigger 16 with four sides. In other embodiments, the trigger guard 10 may be mounted to the body 14 of the welding gun surrounding the trigger 16. In all embodiments, the trigger guard 10 is secured to the welding gun 12 at a location and orientation that allows for the plate 18 to overlie at least a portion of the trigger 16.

In the embodiments shown, the plate 18 is parallel with the trigger 16 and extends beyond all four sides of the trigger. The plate 18 may also be referred to as a guard or cover and can be made from any suitable metal or composite material. The plate 18 as shown in the figures is rectangular and elongated but can take a different shape to accommodate for the trigger 16 of any welding gun. One or both ends could be rounded or may be beveled for handling or aesthetic purposes.

The plate 18 of the present embodiment has integral flanges 24 at one end of the plate for pivotally mounting the trigger guard 10 to the welding gun 12. The flanges 24 form a first open or U-shaped channel 34 with an inner face or back of the plate 18. The trigger guard could be built with separate components for the plate 18 and flanges 24, such as in an embodiment with a composite material plate or comprising multiple materials. The flanges 24 have apertures for receiving screws, pins, or any other suitable fastener 25 to allow pivotable connection to the body 14 of the welding gun within the channel 34.

A biasing member such as a spring 20 is mounted on the opposite end of the plate 18 from the plate mounting flanges 24. The biasing spring 20 of FIGS. 1-2 is a lever 26 connected to a torsion spring 28 for biasing the plate 18 into a released position that is generally parallel to and spaced from the trigger 16. When a user applies enough pressure to the plate 18 to compress the biasing spring 20, the plate goes into an engaged position that contacts the trigger 16 and is non-parallel to the trigger and body 14 of the welding gun.

The plate 18 may have two additional flanges 30 forming a second open or U-shaped channel 36 for mounting the torsion spring 28, which generally forms a modified U-shape for flanking the lever 26. Ends of the torsion spring or other fasteners 31 may be used to secure the torsion spring 28 with the spring mounting flanges 30.

In the embodiment shown, an aperture 22 in the plate allows for a head 26a of the lever to protrude from a front or outer face of the plate 18. The stem 26b of the lever is engaged by the U-shape of the torsion spring 28, both of which protrude from a back or inner face of the plate 18 that faces the welding gun 12. When the trigger guard 10 is in the released position, the lever 26 is biased to be perpendicular to the plate 18 and maintains the plate in a parallel position to the trigger 16 and thereby prevents inadvertent activation of the welding gun. When the trigger guard 10 is in the engaged position, pressure is applied to the lever head 26a which pushes against the torsion spring 28 to rotate the lever 26 into a horizontal position that is parallel with the plate 18 and allows the plate to abut or engage the trigger 16. That is, in order to activate the trigger 16 via the plate 18, the operator can displace the lever head 26a against the torsion spring 28.

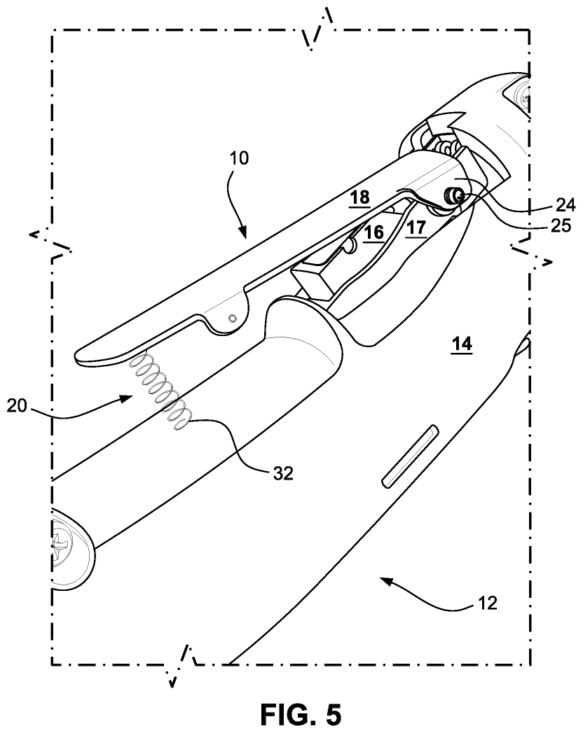

Other embodiments of the trigger guard 10 may utilize a compression spring 32 (see, e.g., FIG. 5) secured to the inner face or back of the plate 18 or may utilize any other suitable biasing spring. Alternate embodiments of the biasing spring may eliminate any of the lever, plate aperture, or spring mounting flanges.

As shown in FIGS. 1-2, the trigger guard 10 is mounted to the welding gun 12 such that the plate 18 is generally limited to pivoting towards the body 14 of the welding gun to the engaged position and then pivoting back to the released position. The trigger guard 10 does not have the flexibility to pivot substantially outwardly from the horizontal released position. In this configuration, it is difficult for the user to slide a finger underneath the trigger guard 10 to press down directly on the trigger 16.

In an embodiment where the biasing member is a compression spring 32, with reference for example to FIG. 5, the pivotal movement of the plate 18 is preferably limited to the height of the compression spring in its released position, i.e., the spring is neither compressed nor expanded. The user must use the necessary force on the trigger guard 10 in order to depress the spring 20 and activate the welding gun 12, which prevents injury from mishandling the gun or accidental pressing of the trigger 16 when the gun is set down.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A guard for a welding gun having a trigger and a body, comprising:
a plate having two elongated sides, two ends, a front, and a back;
a first pair of flanges extending from the elongated sides of the plate and forming a first open channel with the back of the plate; and
a biasing member secured to the back of the plate,
wherein the plate is configured to be pivotally secured to the welding gun body by fasteners engaging the first pair of flanges and the welding gun body, and wherein at least a portion of the plate overlies the welding gun trigger.

2. The welding gun guard of claim 1, wherein at least a portion of the back of the plate extends beyond the welding gun trigger, the biasing member being positioned to bias the plate away from the welding gun trigger.

3. The welding gun guard of claim 2, the plate further comprising a second pair of flanges forming a second open channel with the back of the plate, wherein the biasing member is connected to the plate via the second pair of flanges.

4. The welding gun guard of claim 3, wherein the biasing member comprises a lever and a torsion spring.

5. The welding gun guard of claim 4, further comprising an aperture in the plate adjacent the second pair of flanges, the lever extending from both sides of the aperture.

6. The welding gun guard of claim 5, wherein the torsion spring is mounted to the second pair of flanges and is configured to bias the lever to extend from both sides of the aperture, the lever being rotatable to a position disposed on one side of the aperture and parallel with the plate when pressure is applied to the plate.

7. The welding gun guard of claim 1, wherein the biasing member comprises a lever connected to the plate and pivotable between an engaged position, in which the plate is prevented from displacement, and a disengaged position, in which the plate is freely displaceable to activate the welding gun trigger.

8. The welding gun guard of claim 7, wherein the plate comprises an aperture, and wherein the lever comprises a head pivoted through the aperture when the lever in in the engaged position, whereby the head is manually accessible and displaceable by an operator.

9. The welding gun guard of claim 7, wherein the biasing member comprises a torsion spring connected between the plate and a stem of the lever, the torsion spring being configured to bias the lever toward the engaged position.

10. The welding gun guard of claim 9, wherein the torsion spring is U-shaped, extending from one side of the plate, across the stem of the lever, to an opposite side of the plate.

11. The welding gun guard of claim 1, wherein the biasing member comprises a compression spring connected to the plate and engageable with the welding gun body, the compression spring being configured to bias the plate away from the trigger.

12. A guard for a welding gun having a trigger and a body, comprising:
a plate having two elongated sides, two ends, a front, and a back; and
a first pair of flanges extending from the elongated sides of the plate and forming a first open channel with the back of the plate,
wherein the plate is pivotally secured to the welding gun body by fasteners engaging the first pair of flanges and the welding gun body, and wherein at least a portion of the back of the plate overlies and extends beyond the welding gun trigger, the back of the plate including a compression spring biasing the plate away from the welding gun trigger.

13. The welding gun guard of claim 12, wherein the pivotal movement of the plate is limited to the height of the compression spring in a released position.

14. A guard for a welding gun trigger forming part of a welding gun handle, the guard comprising:
a plate pivotably mountable to the welding gun handle overlying the welding gun trigger, the plate being pivotable between a released position spaced from the welding gun trigger and an engaged position activating the welding gun trigger, the plate including an aperture therein; and
a lever pivotably coupled with the plate and extending through the aperture in the plate, the lever being pivotable relative to the plate between an upright position essentially perpendicular to the plate and a flat position essentially parallel to the plate, wherein the lever is biased toward the upright position via a biasing member, and wherein in the upright position, the lever is engageable with the handle to prevent the plate from engaging the welding gun trigger.

15. The guard of claim 14, wherein the biasing member comprises a torsion spring connected between the plate and a stem of the lever.

16. The guard of claim 15, wherein the torsion spring is U-shaped, extending from one side of the plate, across the stem of the lever, to an opposite side of the plate.

17. The guard of claim 15, wherein with the lever in the upright position, a head of the lever is positioned through the aperture on a side of the plate opposite from the welding gun trigger, whereby the head is manually accessible and displaceable by an operator.

18. The guard of claim 14, wherein the biasing member comprises a compression spring.

19. The guard of claim 18, wherein the compression spring is connected to the plate and engageable with the welding gun body, the compression spring being configured to bias the plate away from the welding gun trigger.
